(19) United States
(12) Patent Application Publication
(10) Pub. No.: US 2007/0081538 A1
(43) Pub. Date: Apr. 12, 2007

(54) Off-load engine to re-sequence data packets within host memory

(75) Inventor: Roxanna Ganji, Fremont, CA (US)

Correspondence Address: HAVERSTOCK & OWENS LLP, 162 NORTH WOLFE ROAD, SUNNYVALE, CA, 94086, US

(73) Assignee: Alliance Semiconductor

(21) Appl. No.: 11/249,690

(22) Filed: Oct. 12, 2005

(51) Int. Cl. H04L 12/56; H04L 12/54

(52) U.S. Cl. 370/394; 370/428

(57) ABSTRACT

A re-sequencing system offloads the cycle intensive task of re-sequencing TCP packets from host memory using a partial offload engine to re-sequence out-of-sequence data packets. However, as opposed to re-ordering the actual data packets, no actual data copy is needed. Instead, packet descriptors associated with each data packet are generated, and it is the packet descriptors that are re-sequenced. The data packets themselves are temporarily stored in packet buffers while the packet descriptors are sorted into sequence. The re-sequencing system preferably re-sequences a data stream of TCP data packets received from an ethernet network. The re-sequencing system is implemented within a computing device, preferably a personal computer or a server.

### FIELD OF THE INVENTION

The present invention relates to the field of data transmission. More particularly, the present invention relates to the field of re-sequencing data packets of a data stream within host memory.

### BACKGROUND OF THE INVENTION

Many applications use TCP protocol for transferring data over the internet. Conventionally, microprocessors on both ends of the internet connection perform all the processing needed to maintain a TCP connection. Recently, networking speed has increased at a faster pace than microprocessor speed. Therefore, microprocessors are not able to process at a speed necessary to match the network traffic rate, thereby creating a bottleneck. Such a bottleneck reduces throughput and uses precious CPU cycles, leaving limited processing for other applications running on the system.

TCP offload engines reduce the burden on the system microprocessor by taking care of some of the TCP/IP functions in hardware. Conventionally, two types of TCP offload engines are available. One type is a full TCP/IP offload where hardware completely offloads TCP processing from the host microprocessor. This solution, however, requires a complex and expensive TCP offload engine chip. Additionally, this full offload solution requires dedicated external memory which further increases cost. A second type of TCP offload engine only partially offloads the cycle intensive TCP/IP functions in hardware, and allows the microprocessors to perform the remaining processing. Existing TCP partial offload engines provide TCP/IP checksum and large send offload. However, there remains a need to further offload more TCP functions from the host microprocessor.

### SUMMARY OF THE INVENTION

Embodiments of the present invention are directed to offloading the cycle intensive task of re-sequencing TCP packets from host memory. A re-sequencing system utilizes an offload engine to re-sequence out-of-sequence data packets. However, as opposed to re-ordering the actual data packets, no actual data copy is needed. Instead, packet descriptors associated with each data packet are generated, and it is the packet descriptors that are re-sequenced. The data packets themselves are temporarily stored in packet buffers while the packet descriptors are sorted into sequence. The re-sequencing system preferably re-sequences a data stream of TCP data packets received from the network. The re-sequencing system is implemented within a computing device, preferably a personal computer or a server.

In one aspect of the present invention, an apparatus to re-sequence data packets includes a decode unit, a host memory, and a scheduler. The decode unit receives a plurality of data packets over one or more data connections, wherein the decode unit outputs a packet descriptor associated with each data packet, further wherein the packet descriptor includes a data packet sequence number associated with the data packet. The host memory includes a data packet memory to store each data packet and a descriptor memory area to store each packet descriptor. The scheduler configures the packet descriptors in-sequence according to the data packet sequence numbers such that each data packet stored in data packet memory is output from host memory according to the configured in-sequence packet descriptors. Preferably, each data connection comprises a TCP connection and each data packet comprises a TCP packet. The data packet memory can be a plurality of packet buffers. The descriptor memory area can include an in-sequence descriptor memory area wherein if the data packet received by the decode unit is in-sequence, then the packet descriptor corresponding to the data packet is stored in the in-sequence descriptor memory area. The descriptor memory area can also include an out-of-sequence descriptor memory area wherein if the data packet output from the decode unit is out-of-sequence, then the packet descriptor corresponding to the out-of-sequence data packet is stored in the out-of-sequence descriptor memory area. The out-of-sequence descriptor memory area can be allocated according to a maximum number of supported simultaneous TCP connections such that each packet descriptor stored in the out-of-sequence descriptor memory area is associated with a particular TCP data connection. The scheduler preferably periodically accesses the packet descriptors in the out-of-sequence descriptor memory area for the particular data connection and sorts the accessed packet descriptors thereby forming a sorted list of packet descriptors for each data connection. The apparatus can also include a connection memory for each data connection to maintain a next expected sequence number for each TCP data connection monitored for re-sequencing. The scheduler preferably matches the next expected sequence number to the data packet sequence number of a first packet descriptor in the sorted list of packet descriptors to determine a next packet descriptor to store in the in-sequence descriptor memory area. The data packets stored in the data packet memory are output according to the packet descriptors stored in the in-sequence memory area. Each packet descriptor preferably includes a pointer to an address in the data packet memory that includes the data packet corresponding to the packet descriptor.

In another aspect of the present invention, a system to re-sequence data packets includes an offload engine and a host memory. The offload engine receives a plurality of data packets over one or more data connections, wherein the decode unit outputs a packet descriptor associated with each data packet, further wherein the packet descriptor includes a data packet sequence number associated with the data packet, and to configure the packet descriptors in-sequence according to the data packet sequence numbers. The host memory includes a data packet memory to store each data packet and a descriptor memory area to store each packet descriptor, wherein each data packet stored in the data packet memory is output from the host memory according to the configured in-sequence packet descriptors. Preferably, each data connection comprises a TCP connection and each data packet comprises a TCP packet. The data packet memory preferably comprises a plurality of packet buffers. The offload engine preferably comprises a decode unit to receive the one or more data connections and to output the data packet and the packet descriptor associated with each data packet. The offload engine also includes a scheduler to configure the packet descriptors in-sequence. The descriptor memory area can include an in-sequence descriptor memory area wherein if the data packet received by the decode unit is in-sequence, then the packet descriptor corresponding to the data packet is stored in the in-sequence descriptor memory area. The descriptor memory area can also include an out-of-sequence descriptor memory area wherein if the data packet received by the decode unit is out-of-sequence, then the packet descriptor corresponding to the out-of-sequence data packet is stored in the out-of-sequence descriptor memory area. The out-of-sequence descriptor memory area can be allocated according to a maximum number of supported simultaneous TCP connections such that each packet descriptor stored in the out-of-sequence descriptor memory area is associated with a particular TCP data connection. The scheduler preferably periodically accesses the packet descriptors stored in the out-of-sequence descriptor memory area for the particular data connection and sorts the accessed packet descriptors thereby forming a sorted list of packet descriptors for each data connection. The offload engine can also include a connection memory for each data connection to maintain a next expected sequence number for each TCP data connection monitored for re-sequencing. The scheduler preferably matches the next expected sequence number to the data packet sequence number of a first packet descriptor in the sorted list of packet descriptors to determine a next packet descriptor to store in the in-sequence descriptor memory area. The data packets stored in the data packet memory are preferably output according to the packet descriptors stored in the in-sequence memory area. Each packet descriptor preferably includes a pointer to an address in the data packet memory that includes the data packet corresponding to the packet descriptor.

In yet another aspect of the present invention. a method of re-sequencing data packets includes receiving a plurality of data packets over one or more data connections, generating a packet descriptor associated with each data packet, wherein the packet descriptor includes a data packet sequence number associated with the data packet, storing each data packet in a data packet memory, storing each packet descriptor in a descriptor memory area, configuring the packet descriptors in-sequence according to the data packet sequence numbers, and outputting each data packet stored in data packet memory according to the configured in-sequence packet descriptors. The method of also includes determining if each data packet is received in-sequence, and if the data packet is in-sequence, then preferably storing the associated packet descriptor in an in-sequence descriptor memory area of the descriptor memory area. If the data packet is not in-sequence, then the method preferably includes storing the associated packet descriptor in an out-of-sequence descriptor memory area of the descriptor memory area. The method preferably includes allocating the out-of-sequence descriptor memory area according to a maximum number of supported simultaneous TCP connections such that each packet descriptor stored in the out-of-sequence descriptor memory area is associated with a particular TCP data connection. The method preferably includes periodically accessing the packet descriptors stored in the out-of-sequence descriptor memory area for the particular data connection and sorting the accessed packet descriptors thereby forming a sorted list of packet descriptors for each data connection. The method preferably includes maintaining a next expected sequence number for each TCP data connection monitored for re-sequencing. The method preferably includes matching the next expected sequence number to the data packet sequence number of a first packet descriptor in the sorted list of packet descriptors to determine a next packet descriptor to store in the in-sequence descriptor memory area. Outputting the data packets stored in the data packet memory is preferably performed according to the packet descriptors stored in the in-sequence memory area. The method can also include determining if each received data packet is monitored for re-sequencing prior to generating the packet descriptor.

### BRIEF DESCRIPTION OF THE DRAWINGS

FIG. 1 illustrates a block diagram of the internal components of an exemplary computing device 10 implementing the re-sequencing system of the present invention.

FIG. 2 illustrates an exemplary functional block diagram of the re-sequencing system of the present invention.

FIG. 3 illustrates a generalized method of operation related to the re-sequencing system of the present invention.

Embodiments of the re-sequencing system are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

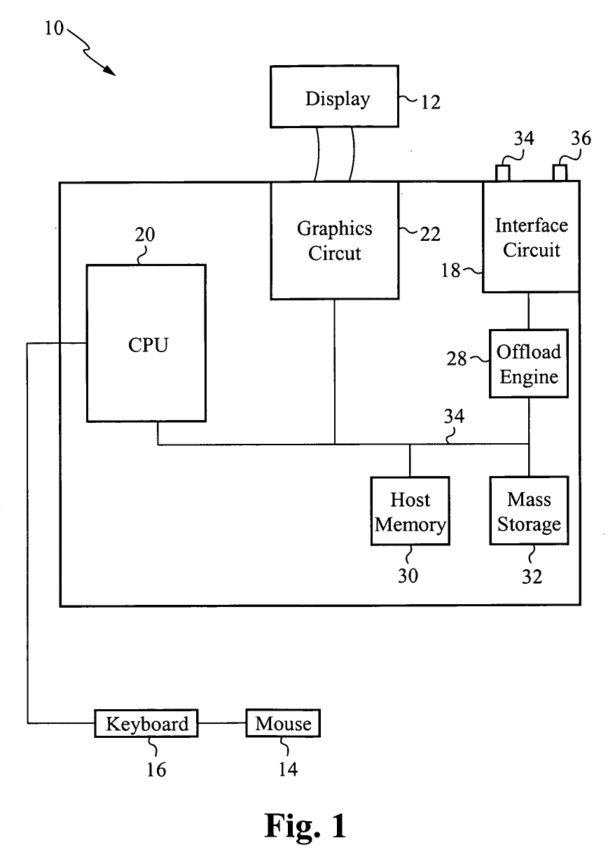

FIG. 1 illustrates a block diagram of the internal components of an exemplary computing device 10 implementing the re-sequencing system of the present invention. The computing device 10 includes a central processor unit (CPU) 20, an offload engine 28, a host memory 30, a video memory 22, a mass storage device 32, and an interface circuit 18, all coupled together by a conventional bidirectional system bus 34. The interface circuit 18 preferably includes a physical interface circuit for sending and receiving communications over an ethernet network. Alternatively, the interface circuit 18 is configured for sending and receiving communications over any packet based network. In the preferred embodiment of the present invention, the interface circuit 18 is implemented on an ethernet interface card within the computing device 10. However, it should be apparent to those skilled in the art that the interface circuit 18 can be implemented within the computing device 10 in any other appropriate manner, including building the interface circuit onto the motherboard itself. The interface circuit 18 preferably includes two ports 34 and 36. Alternatively, the interface circuit 18 can include more, or less than two ports. The mass storage device 32 may include both fixed and removable media using any one or more of magnetic, optical or magneto-optical storage technology or any other available mass storage technology. The system bus 34 enables access to any portion of the memory 30 and 32 and data transfer between and among the CPU 20, the offload engine 28, the host memory 30, the video memory 22, and the mass storage device 22. Host memory 30 functions as system main memory, which is used by CPU 20.

The computing device 10 is also coupled to a number of peripheral input and output devices including a keyboard 16, a mouse 14, and an associated display 12. The keyboard 16 is coupled to the CPU 20 for allowing a user to input data and control commands into the computing device 10. The mouse 14 is coupled to the keyboard 16, or coupled to the CPU 20, for manipulating graphic images on the display 12 as a cursor control device. The computing device 10 includes graphics circuitry 22 to convert data into signals appropriate for display. It is understood that the configuration of computing device 10 shown in FIG. 1 is for exemplary purposes only and that computing device 10 can be configured in any other conventional manner.

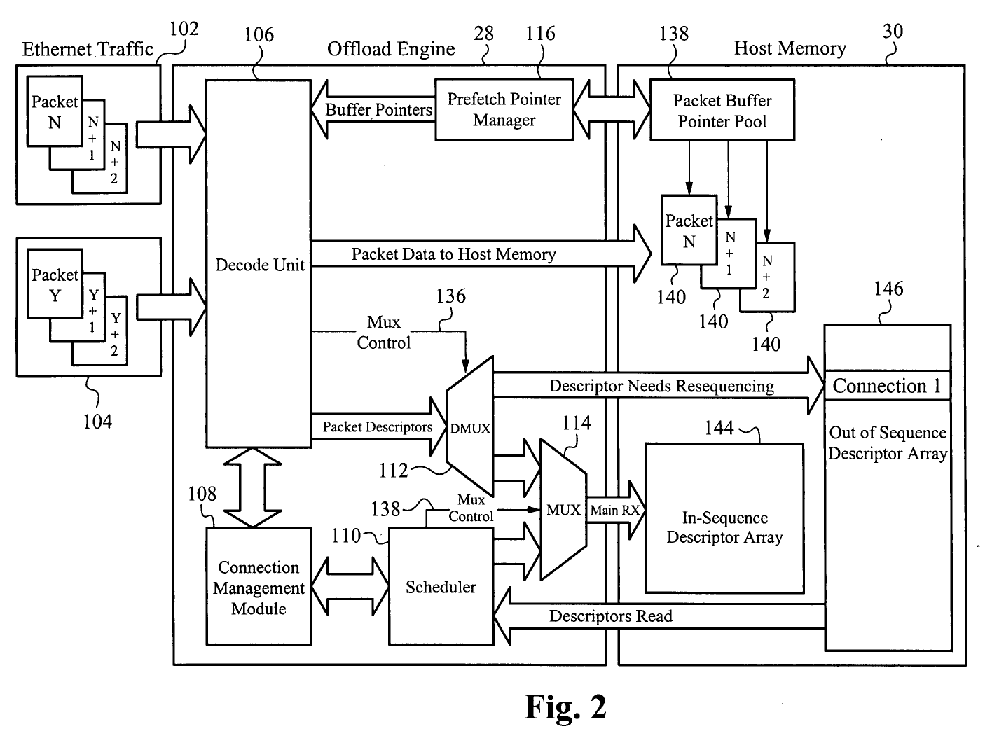

FIG. 2 illustrates an exemplary functional block diagram of the re-sequencing system of the present invention, including the offload engine 28 and the host memory 30. Data flow between the various components of the offload engine 28 and the host memory 30 are shown as arrows in FIG. 2. It is understood that the data flow shown in FIG. 2 is for exemplary purposes only and that other data flow between components in the offload engine 28 and the host memory 30 is present during operation of the re-sequencing system.

A data stream 102 corresponds to data received on the port 34 (FIG. 1) and a data stream 104 corresponds to data received on the port 36 (FIG. 1). Each data stream comprises a series of data packets, such as data packets N, N+1, and N+2 in the data stream 102, and data packets Y, Y+1, and Y+2 in the data stream 104, where the order of the packets in each of the data streams 102 and 104 corresponds to the order of the packets received at the ports 34 and 36, respectively. Each data packet is identified by its TCP/IP socket pair information, which identifies the IP source address, the IP destination address, the TCP source port, and the TCP destination port for a given connection between a source device and a destination device, such as the computing device 10. In an ethernet network where multiple computing devices are typically connected, the connection between the computing device 10 and each source device is uniquely identified by the TCP/IP socket pair information.

For clarity of discussion, description of the offload engine 28 and the host memory 30 is described below in terms of a single connection, where the data packets N, N+1, and N+2 are associated with “connection 1.” Although a single connection is described, it is understood that the offload engine 28 and the host memory 30 are configured to simultaneously process multiple connections over the data stream 102 and multiple connections over the data stream 104. In the preferred embodiment, the offload engine 28 and the host memory 30 are configured to process up to 1024 simultaneous connections. Alternatively, more or less than 1024 simultaneous connections can be processed.

The offload engine 28 preferably includes a decode unit 106, a connection management module 108, a scheduler 110, a prefetch pointer manager 116, a de-multiplexer 136, and a multiplexer 114. The host memory 30 preferably includes a packet buffer pointer pool 138, a plurality of packet buffers 140, an in-sequence descriptor array 144, and an out-of-sequence descriptor array 146.

The decode unit 106 is coupled to receive the data stream 102 and the data stream 104 from the interface circuit 118 (FIG. 1). The decode unit 102 decodes the packet header information for each received data packet, for example data packets N, N+1, and N+2, and sends the decoded packet header information to the connection management module 108. The decode unit 102 sends each data packet to a packet buffer 140 within the host memory 30. The packet header information preferably indicates a packet type, the TCP/IP socket pair, and a sequence number of the data packet that indicates a relative intended position within the data stream. Using this packet header information, the decode unit 106 forms a packet descriptor and determines if the data packet is in sequence or out of sequence. The packet descriptor functions as a pointer and includes the sequence number of the data packet and the address of the packet buffer storing the corresponding data packet.

The packet buffer pointer pool 138 maintains a list of pointers for each packet buffer 140 available for storing data packets. The prefetch pointer manager 116 manages the list of pointers in the packet buffer pointer pool 138. The decode unit 106 receives the packet buffer address from the prefetch pointer manager 116.

Regardless of whether or not the received data packet is in sequence or out of sequence, the data packet is sent to the packet buffer 140. If the decode unit 106 determines that the received data packet is in sequence, then the packet descriptor corresponding to the in sequence data packet is sent to the in-sequence descriptor array 144. The in-sequence descriptor array 144 stores the packet descriptors for all TCP packets determined to be in sequence and also all non-TCP packets.

If the decode unit 106 determines that the received data packet is out of sequence, then the packet descriptor corresponding to the out of sequence data packet is sent to the out of sequence descriptor array 146. The out of sequence descriptor array 146 temporarily stores packet descriptors for out of sequence data packets. The out of sequence descriptor array 146 is sub-divided by connection such that all out of sequence packet descriptors stored in the out of sequence descriptor array 146 are grouped and identified by connection. For each connection within the out of sequence descriptor array 146, the out of sequence packet descriptors are stored in the order received.

In the preferred embodiment, the packet descriptors are sent to either the out of sequence descriptor array 146 or the in-sequence descriptor array 144 via the de-multiplexor 112. The de-multiplexor 112 is under control of the decode unit 106. The decode unit 106 sends a control signal to the de-multiplexor 112 via the control line 136. The control signal instructs the de-multiplexor to either direct the packet descriptor to the out of sequence descriptor array 146 or to the in-sequence descriptor array 144.

The connection management module 108 preferably maintains two memory areas, a connection look up table and a connection memory. Alternatively, the connection look up table and the connection memory are maintained in a single memory area. The connection look up table stores TCP/IP socket pair information. The connection memory stores information needed for tracking packet sequence numbers and information for receiving packet descriptors from the out of sequence descriptor array 146. The connection management module 108 adds an entry to the connection look up table when a new connection is established between two computing devices 10 via a TCP connection. The new entry in the connection look up table includes the TCP/IP socket pair information of the new connection. Each data packet received by the decode unit 106 is examined to determine if the data packet corresponds to a connection which is being monitored for re-sequencing. A connection is monitored for re-sequencing when there is a match for its TCP/IP socket pair in the connection look up table.

For each connection, the connection memory stores the expected sequence number for the next data packet for each TCP connection. The sequence number stored in the connection memory is compared to the sequence number of the data packet received by the decode unit 106. The decode unit 106 makes such a comparison to determine if a received data packet is in sequence or out of sequence.

The scheduler 110 periodically examines the connection memory within the connection management module 108 to determine which connections have pending data packets, as signified by packet descriptors stored in the out of sequence descriptor array 146. Preferably, the connections are monitored in a round robin manner. If the scheduler 110 determines that a connection has pending data packets, then the scheduler 110 reads the packet descriptors for that connection from the out of sequence descriptor array 146, reorders the read packet descriptors into a sorted list by their sequence numbers, and compares the sequence numbers in the sorted list with the next expected sequence number for that connection. Packet descriptor(s) from the sorted list that match the next expected sequence number(s) are transferred to the in sequence descriptor array 144, and the next expected sequence number is updated in connection memory for that connection. In this manner, reordering of the packet descriptors stored in the out of sequence descriptor array 146 is performed on the fly as the scheduler 110 examines the out of sequence descriptor array 146 for packet descriptors to be transferred to the in sequence descriptor array 144.

Activities performed by the scheduler 110 are independent of the activities performed by the decode unit 106. As the scheduler 110 determines if packet descriptors stored in the out of sequence descriptor array 146 are to be transferred to the in sequence descriptor array 144, the decode unit 106 is independently determining if the sequence number of a received data packet is in sequence and if the corresponding packet descriptor is to be transferred to the in sequence descriptor array 144. The multiplexor 114 preferably comprises arbitration logic under the control of the scheduler 110 via control signal 138 to ensure that the proper packet descriptor is transferred to the in sequence descriptor array 144 from either the scheduler 110 or the decode unit 106, and that the scheduler 110 and the decode unit 106 do not override the same area of memory.

Operation of the re-sequencing system is described below for a single connection. The decode unit 106 receives a data stream 102 including a series of data packets. The packet header of each data packet is analyzed to determine the TCP/IP socket pair information and if the corresponding connection is currently monitored by connection management module 108 for re-sequencing. If the determined TCP/IP socket pair is not currently monitored by the connection management module, then if possible the TCP/IP socket information is added to a connection look up module. Using the packet header information, the decode unit 106 determines the sequence number and generates the packet descriptor corresponding to the received data packet.

The connection management module 108 maintains the connection look up table and also tracks the next expected sequence number for a data packet received by the decode unit 106 to be considered in sequence. The decode unit 106 compares the sequence number of the received data packet to the next expected sequence number provided by the connection management module 108 to determine if the received data packet is in sequence or out of sequence.

If it is determined by the decode unit 106 that the received data packet is in sequence, then the packet descriptor is sent to the in sequence descriptor array 144. The in sequence descriptor array 144 stores a list of descriptors corresponding to all data packets currently stored in the packet buffers 140 that are determined to be in sequence. If it is determined by the decode unit 106 that the received data packet is out of sequence, then the packet descriptor is sent to the out of sequence descriptor array 146. The out of sequence descriptor array 146 is sub-divided by connection, and for each connection, the out of sequence descriptor array 146 stores a list of packet descriptors corresponding to all data packets currently stored in the packet buffer 140 that are determined to be out of sequence. Regardless of whether the received data packet is determined to be in sequence or out of sequence, the actual data packet is stored in the packet buffer 140.

The scheduler 110 periodically examines connection memory within the connection management module 108 to determine if any out of sequence packet descriptors are stored in the out of sequence descriptor array 146. If any out of sequence packet descriptors are determined to be stored in the out of sequence descriptor array 146, then the scheduler 110 reads the packet descriptors for that connection from the out of sequence descriptor array 146, reorders the read packet descriptors into a sorted list by their sequence numbers, and compares the sequence numbers in the sorted list with the next expected sequence number for that connection. Packet descriptor(s) from the sorted list that match the next expected sequence number(s) are transferred to the in sequence descriptor array 144, and the next expected sequence number is updated in connection memory for that connection.

Regardless of the order in which the data packets are received by the re-sequencing system, an in-sequence list of packet descriptors is formed within the in sequence descriptor array 144. The data packets are read from the packet buffers 140 in sequence according to the in sequence list of packet descriptors stored in the in sequence descriptor array 144.

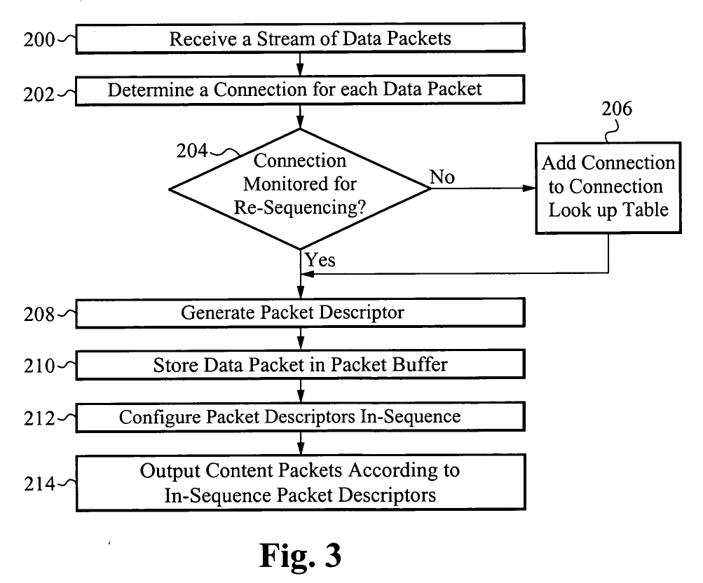

FIG. 3 illustrates a generalized method of operation related to the re-sequencing system of the present invention. At a step 200, the re-sequencing system receives a stream of data packets. At the step 202, for each data packet received, a corresponding connection based on the TCP/IP socket pair information is determined. At the step 204, it is determined if each data packet received is monitored for re-sequencing. If it is determined at the step 204 that the data packet is not monitored for re-sequencing, then the method moves to a step 206. At the step 206, the TCP/IP socket pair information for the connection is added to a connection look up table. If it is determined at the step 204 that the data packet is monitored for re-sequencing, or after the connection is added to the connection look up table in the step 206, then the method moves to a step 208. At the step 208, a packet descriptor is generated for each data packet. At the step 210, the data packet is stored in a data packet buffer. At the step 212, the packet descriptors are sorted in sequence to form a list of in sequence packet descriptors. At the step 214, the data packets stored in the data packet memory are output according to the list of in sequence packet descriptors.

The re-sequencing system of the present invention provides extra memory bandwidth and reduced processing by copying the data packet only once into the host memory, regardless of whether the data packet is received in sequence or out of sequence. Instead of repeatedly copying the various larger-sized data packets during a re-ordering process, smaller-sized packet descriptors are used for the re-ordering process, and no further copying of the data packets is performed.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. An apparatus to re-sequence data packets, the apparatus comprising:
a. a decode unit to receive a plurality of data packets over one or more data connections, wherein the decode unit outputs a packet descriptor associated with each data packet, further wherein the packet descriptor includes a data packet sequence number associated with the data packet;
b. a host memory including a data packet memory to store each data packet and a descriptor memory area to store each packet descriptor; and
c. a scheduler to configure the packet descriptors in sequence according to the data packet sequence numbers such that each data packet stored in data packet memory is output according to the configured in sequence packet descriptors.

2. The apparatus of claim 1 wherein each data connection comprises a TCP connection.

3. The apparatus of claim 1 wherein each data packet comprises a TCP packet.

4. The apparatus of claim 1 wherein the data packet memory comprises a plurality of packet buffers.

5. The apparatus of claim 1 wherein the descriptor memory area comprises an in sequence descriptor memory area wherein if the data packet received by the decode unit is in sequence, then the packet descriptor corresponding to the data packet is stored in the in sequence descriptor memory area.

6. The apparatus of claim 5 wherein the descriptor memory area further comprises an out-of-sequence descriptor memory area wherein if the data packet received by the decode unit is out-of-sequence, then the packet descriptor corresponding to the out-of-sequence data packet is stored in the out-of-sequence descriptor memory area.

7. The apparatus of claim 6 wherein the out-of-sequence descriptor memory area is allocated according to a maximum number of supported simultaneous TCP data connections such that each packet descriptor stored in the out-of-sequence descriptor memory area is associated with a particular TCP data connection.

8. The apparatus of claim 7 wherein the scheduler periodically accesses the product descriptors stored in the out-of-sequence descriptor memory area for the particular data connection and sorts the accessed packet descriptors thereby forming a sorted list of packet descriptors for each data connection.

9. The apparatus of claim 8 further comprising a connection memory for each data connection to maintain a next expected sequence number for each TCP data connection monitored for re-sequencing.

10. The apparatus of claim 9 wherein the scheduler matches the next expected sequence number to the data packet sequence number of a first packet descriptor in the sorted list of packet descriptors to determine a next packet descriptor to store in the in sequence descriptor memory area.

11. The apparatus of claim 10 wherein data packets stored in the data packet memory are output according to the packet descriptors stored in the in sequence memory area.

12. The apparatus of claim 1 wherein each packet descriptor includes a pointer to an address in the data packet memory that includes the data packet corresponding to the packet descriptor.

13. A system to re-sequence data packets, the system comprising:
a. an offload engine to receive a plurality of data packets over one or more data connections, wherein the decode unit outputs a packet descriptor associated with each data packet, further wherein the packet descriptor includes a data packet sequence number associated with the data packet, and to configure the packet descriptors in sequence according to the data packet sequence numbers; and
b. a host memory including a data packet memory to store each data packet and a descriptor memory area to store each packet descriptor;
wherein each data packet stored in the data packet memory is output from the host memory according to the configured in sequence packet descriptors.

14. The system of claim 13 wherein each data connection comprises a TCP connection.

15. The system of claim 13 wherein each data packet comprises a TCP packet.

16. The system of claim 13 wherein the data packet memory comprises a plurality of packet buffers.

17. The system of claim 13 wherein the offload engine comprises a decode unit to receive the one or more data connections and to output the data packet and the packet descriptor associated with each data packet.

18. The system of claim 17 wherein the offload engine further comprises a scheduler to configure the packet descriptors in sequence.

19. The system of claim 18 wherein the descriptor memory area comprises an in sequence descriptor memory area wherein if the data packet received by the decode unit is in sequence, then the packet descriptor corresponding to the data packet is stored in the in sequence descriptor memory area.

20. The system of claim 19 wherein the descriptor memory area further comprises an out-of-sequence descriptor memory area wherein if the data packet received by the decode unit is out-of-sequence, then the packet descriptor corresponding to the out-of-sequence data packet is stored in the out-of-sequence descriptor memory area.

21. The system of claim 20 wherein the out-of-sequence descriptor memory area is allocated according to a maximum number of supported simultaneous TCP data connections such that each packet descriptor stored in the out-of-sequence descriptor memory area is associated with a particular TCP data connection.

22. The system of claim 21 wherein the scheduler periodically accesses the packet descriptors stored in the out-of-sequence descriptor memory area for the particular data connection and sorts the accessed packet descriptors thereby forming a sorted list of packet descriptors for each data connection.

23. The system of claim 22 wherein the offload engine further comprises a connection memory for each data connection to maintain a next expected sequence number for each TCP data connection monitored for re-sequencing.

24. The apparatus of claim 23 wherein the scheduler matches the next expected sequence number to the data packet sequence number of a first packet descriptor in the sorted list of packet descriptors to determine a next packet descriptor to store in the in sequence descriptor memory area.

25. The system of claim 24 wherein data packets stored in the data packet memory are output according to the packet descriptors stored in the in sequence memory area.

26. The apparatus of claim 13 wherein each packet descriptor includes a pointer to an address in the data packet memory that includes the data packet corresponding to the packet descriptor.

27. A method of re-sequencing data packets, the method comprising:
a. receiving a plurality of data packets over one or more data connections;
b. generating a packet descriptor associated with each data packet, wherein the packet descriptor includes a data packet sequence number associated with the data packet;
c. storing each data packet in a data packet memory;
d. storing each packet descriptor in a descriptor memory area;
e. configuring the packet descriptors in sequence according to the data packet sequence numbers; and
f. outputting each data packet stored in data packet memory according to the configured in sequence packet descriptors.

28. The method of claim 27 further comprising determining if each data packet is received in sequence, and if the data packet is in sequence, then storing the associated packet descriptor in an in sequence descriptor memory area of the descriptor memory area.

29. The method of claim 28 wherein if the data packet is not in sequence, then the method further comprises storing the associated packet descriptor in an out-of-sequence descriptor memory area of the descriptor memory area.

30. The method of claim 29 further comprising allocating the out-of-sequence descriptor memory area according to a maximum number of supported simultaneous TCP data connections such that each packet descriptor stored in the out-of-sequence descriptor memory area is associated with a particular TCP data connection.

31. The method of claim 30 further comprising periodically accessing the packet descriptors stored in the out-of-sequence descriptor memory area for the particular data connection and sorting the accessed packet descriptors thereby forming a sorted list of packet descriptors for each data connection.

32. The method of claim 31 further comprising maintaining a next expected sequence number for each TCP data connection monitored for re-sequencing.

33. The method of claim 32 further comprising matching the next expected sequence number to the data packet sequence number of a first packet descriptor in the sorted list of packet descriptors to determine a next packet descriptor to store in the in sequence descriptor memory area.

34. The method of claim 33 wherein outputting the data packets stored in the data packet memory is performed according to the packet descriptors stored in the in sequence memory area.

35. The method of claim 27 further comprising determining if each received data packet is monitored for re-sequencing prior to generating the packet descriptor.
